(19) United States
(12) Patent Application Publication
(10) Pub. No.: US 2017/0008025 A1
(43) Pub. Date: Jan. 12, 2017

(54) FOAM GUN WITH FLASHLIGHT

(71) Applicant: Denis Emile Vincent, Timmins (CA)

(72) Inventor: Denis Emile Vincent, Timmins (CA)

(21) Appl. No.: 14/795,881

(22) Filed: Jul. 9, 2015

(51) Int. Cl. B05C 17/005; B05C 17/01; F21V 21/088; F21V 23/04; F21V 33/00; F21L 4/08

(52) U.S. Cl. CPC B05C 17/0052; F21V 33/0084; F21L 4/085; F21V 21/0885; F21V 23/0414; B05C 17/01; F21Y 2101/02; F21W 2111/10

(57) ABSTRACT

A foam gun flashlight capable of dispensing foam, the foam gun flashlight comprising: a flashlight comprising a flashlight body, an on/off switch, a front end with a light source, at least one battery and at least one battery compartment door located at the front end or an opposing back end of the flashlight; and a foam gun comprising a foam gun body, foam container receptacle, a flow control mechanism, a barrel, a nozzle, and a trigger, wherein the flashlight is positioned to illuminate a foam application site.

### FIELD OF THE INVENTION

The present invention is in the field of foam applicator guns and in particular a foam applicator gun comprising a flashlight module directed to providing light at a foam application site.

### BACKGROUND OF THE DISCLOSURE

Applying foam in residential and commercial property during window and door installation and building maintenance is typically accomplished with a foam applicator gun used to propel foam within seams, cracks, etc. Although the foam applicator gun has been available for more than 30 years, none of the current foam applicator guns available in the market comprise a flashlight feature capable of applying light at the application site. This becomes problematic when working in areas without sufficient daylight or indoor lighting to help prevent improper or inaccurate application of foam in these areas. In order to solve the above mentioned problems, there is a need for a foam applicator gun designed with a flashlight suitable to apply a sufficient amount of light to a foam application site.

### SUMMARY OF THE INVENTION

A foam gun flashlight capable of dispensing foam, the foam gun flashlight comprising: a flashlight comprising a flashlight body, an on/off switch, a front end with a light source, at least one battery and at least one battery compartment door located at the front end or an opposing back end of the flashlight; and a foam gun comprising a foam gun body, foam container receptacle, a flow control mechanism, a barrel, a nozzle, and a trigger, wherein the flashlight is positioned to illuminate a foam application site.

### BRIEF DESCRIPTION OF THE DRAWINGS

FIG. 1 is a side view illustration of the foam gun flashlight 10.

FIG. 2 is a rear view illustration of the foam gun flashlight 30 depicting a back end view of the flashlight mounted to foam gun.

FIG. 3 is a front view illustration of the foam gun flashlight 40 depicting a front end view of the flashlight mounted to foam gun.

FIG. 4 is a side view illustration of the flashlight 50 depicting the recharging port 51.

### DETAILED DESCRIPTION OF THE EMBODIMENTS

The following is a detailed description of certain specific embodiments of the foam gun flashlight disclosed herein. In this description reference is made to the drawings.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

### Introduction

In one aspect, disclosed herein is a foam gun flashlight capable of dispensing foam, the foam gun flashlight comprising: a flashlight comprising a flashlight body, an on/off switch, a front end with a light source, at least one battery and at least one battery compartment door located at the front end or an opposing back end of the flashlight; and a foam gun comprising a foam gun body, foam container receptacle, a flow control mechanism, a barrel, a nozzle, and a trigger, wherein the flashlight is positioned to illuminate a foam application site, and the flashlight is a rechargeable flashlight comprising an AC adaptor port, a DC adaptor port, a USB port or a magnetic recharging system to recharge the batteries. In some embodiments, the flashlight is powered with rechargeable batteries or non-rechargeable batteries. In some embodiments, the at least one battery compartment door is a screw off cap.

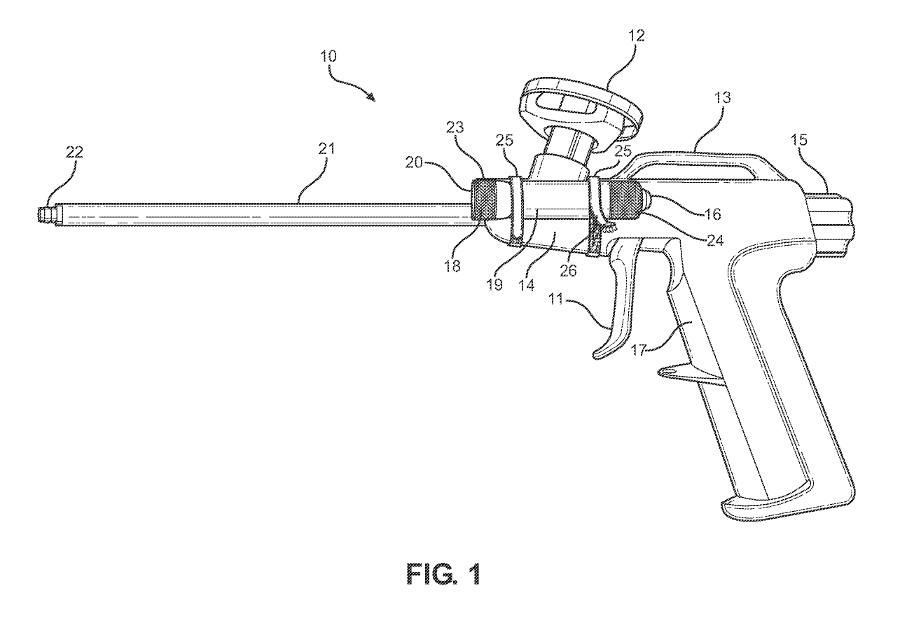

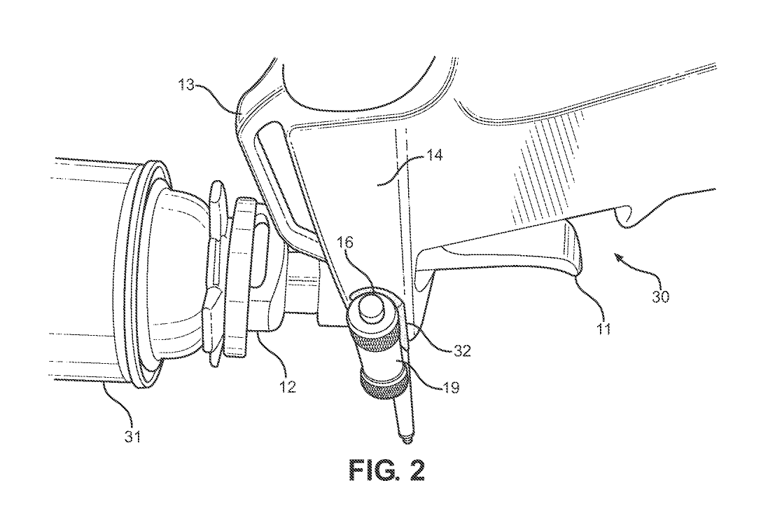

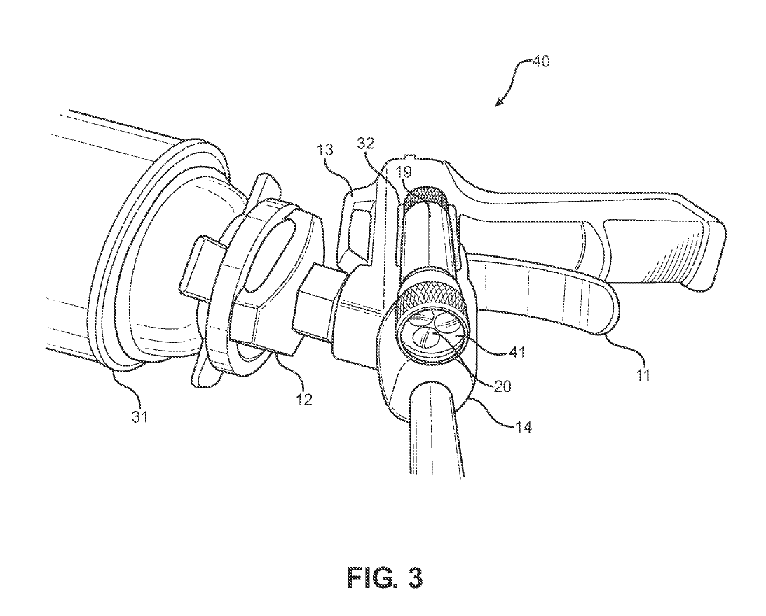

As illustrated with FIG. 1, the foam gun flashlight 10 of the present disclosure comprises a foam gun body 14, a barrel 21, a nozzle 22, a foam can receptacle 12, a trigger 11, a pistol grip handle 17, flow adjuster 15 and an optional second handle 13. The foam gun body 14 may be a standard foam gun body comprising the foam can receptacle 12 and the barrel 21, but the barrel 21 can be of different lengths and internal diameters depending on the size of the application site. As depicted with FIGS. 2 and 3 the foam gun of the present disclosure utilizes the foam can housing 12 for use in attaching a standard foam can 31. The foam gun may be provided by a number of manufacturers, including but not limited to Great Stuff Pro™ Series 13, 14 and 15 foam dispensing guns, and similar foam applicator guns.

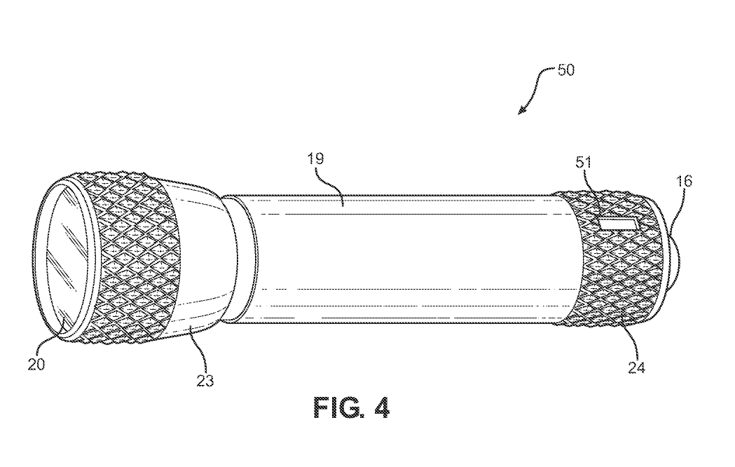

In view of FIGS. 1-4, a feature of the present disclosure is that the foam gun flashlight 10 further comprises an flashlight 19 and a power source such as a rechargeable battery and the flashlight 19 is mounted to the foam gun body 14. The flashlight 19 is used to provide targeting lighting and illumination of a foam application site. The flashlight 19 comprises an on/off switch 16, one or more LEDs 20 and at least one battery compartment door 23 and/or 24. In some embodiments, the light source comprises LEDs or standard light bulbs. In some embodiments, the light source further comprises an adjustable lens 18 and a reflector system 41 as depicted with FIGS. 1 and 3, respectively. In some embodiments, the flashlight is a rechargeable flashlight comprising a recharging port 51 capable to function as an AC adaptor port or a DC adaptor port to recharge the batteries as illustrated with FIG. 4. In some embodiments, the recharging port 51 may comprise prongs capable of connecting with an AC adaptor or a DC adaptor.

The flashlight 19 of the present disclosure may be of different lengths and diameters, and provided by a variety of manufacturers. In some embodiments, the flashlight is between 1.0 inches to 7.0 inches in length, and between about 0.5 inches to 2.0 inches in diameter. In some embodiments, the flashlight is about 2.5 inches in length and about 0.5 inches in diameter. Furthermore, different styles and locations of on/off switches are used with different manufacturers of flashlights. In some embodiments the on/off switch may comprise a portion of a flashlight's body that rotates in one direction for turning the power on and rotation in the opposite direction to turn the power off. In some embodiments, the on/off switch is a push button switch. In some embodiments, the on/off switch is a push button switch located at a back end of the flashlight. As depicted in FIG. 2, a push button on/off switch 16 is located at the back end of the flashlight.

As depicted in FIG. 2, the flashlight 19 may be connected to the foam gun body 14 with glue 32. In some embodiments, the flashlight is connected to the foam gun body 14 with glue 32, wherein the flashlight is connected in a position with the front end of the flashlight 19 aimed at the foam gun's nozzle 22. Alternatively, the flashlight 19 may be connected to the foam gun body 14 with straps and/or clamps 25 as illustrated with FIG. 1. In some embodiments, the foam gun body 14 further comprises at least one strap or clamp 25 for attaching or connecting the flashlight 19 to the foam gun body 14, wherein the flashlight 19 is connected in a position where the front end of the flashlight 19 aimed at the foam gun's nozzle 22. In some embodiments, the flashlight 19 is connected to the foam gun body 14 with glue 32, at least one clamp or at least one strap 25, or a combination thereof, wherein the flashlight is connected in a position where the front end of the flashlight 19 aimed at the foam gun's nozzle 22. In some embodiments, the flashlight is connected to the foam gun body 14 with at least one clamp or at least one strap 25, wherein the at least one clamp or at least one strap 25 comprises a length of plastic, metal or rubber or combination thereof, wherein the at least one clamp or at least one strap 25 is secured to fit tightly over the flashlight 19 and around the foam gun body, wherein the at least one clamp or at least one strap 25 is secured with a hook and loop 26 or hooks or snaps, and when looped around the foam gun body 14 and flashlight 19 and are attached to themselves and the flashlight 19 is connected to the foam gun body, and wherein the flashlight 19 is connected in a position with the front end of the flashlight 19 aimed at the foam gun's nozzle 22.

The application of the disclosed foam gun flashlight represents a paradigm shift with the design and method of use with the foam guns provided by the market today by improving accuracy in the application of the foam by illuminating the application site with the side mounted flashlight as disclosed herein.

The presently disclosed foam gun flashlight is not to be limited in scope by the specific embodiments described herein, which are intended as single illustrations of individual aspects of the presently disclosed foam gun flashlight, and functionally equivalent methods and components are within the scope of the presently disclosed foam gun flashlight. Indeed, various modifications of the presently disclosed foam gun flashlight, in addition to those shown and described herein will become apparent to those skilled in the art from the foregoing description and accompanying drawings. Such modifications are intended to fall within the scope of the appended claims.

What is claimed is:

1. A foam gun flashlight capable of dispensing foam, the foam gun flashlight comprising:
a flashlight comprising a flashlight body, an on/off switch, a front end with a light source, at least one battery and at least one battery compartment door located at the front end or an opposing back end of the flashlight; and
a foam gun comprising a foam gun body, foam container receptacle, a flow control mechanism, a barrel, a nozzle, and a trigger, wherein the flashlight is positioned to illuminate a foam application site.

2. The foam gun flashlight of claim 1, wherein the flashlight is powered with rechargeable batteries or non-rechargeable batteries.

3. The foam gun flashlight of claim 1, wherein the flashlight is a rechargeable flashlight comprising an AC adaptor port, a DC adaptor port, a USB port or a magnetic recharging system to recharge the batteries.

4. The foam gun flashlight of claim 1, wherein the flashlight is a rechargeable flashlight comprising an AC adaptor port or a DC adaptor port to recharge the batteries.

5. The foam gun flashlight of claim 1, wherein the at least one battery compartment door is a screw off cap.

6. The foam gun flashlight of claim 1, wherein the light source comprises LEDs or standard light bulbs.

7. The foam gun flashlight of claim 1, wherein the light source further comprises an adjustable lens and/or a reflector system.

8. The foam gun flashlight of claim 1, wherein the foam gun body further comprises at least one strap or clamp attached to the foam gun body for connecting the flashlight to the foam gun body, wherein the flashlight is connected in a position where the front end of the flashlight aimed at the foam gun's nozzle.

9. The foam gun flashlight of claim 1, wherein the flashlight is connected to the foam gun body with glue, at least one clamp or at least one strap, or a combination thereof, wherein the flashlight is connected in a position where the front end of the flashlight aimed at the foam gun's nozzle.

10. The foam gun flashlight of claim 1, wherein the flashlight is connected to the foam gun body with glue, wherein the flashlight is connected in a position with the front end of the flashlight aimed at the foam gun's nozzle.

11. The foam gun flashlight of claim 1, wherein the flashlight is connected to the foam gun body with at least one clamp or at least one strap, wherein the at least one clamp or at least one strap comprises a length of plastic, metal or rubber or combination thereof, wherein the at least one clamp or at least one strap is secured to fit tightly over the flashlight and around the foam gun body, wherein the at least one clamp or at least one strap is secured with a hook and loop or hooks or snaps, and when looped around the foam gun body and flashlight and are attached to themselves and the flashlight is connected to the foam gun body, and wherein the flashlight is connected in a position with the front end of the flashlight aimed at the foam gun's nozzle.

12. The foam gun flashlight of claim 1, wherein the flashlight is between 1.0 inches to 7 inches in length, and between about 0.5 inches to 2.0 inches in diameter.

13. The foam gun flashlight of claim 1, wherein the flashlight is about 2.5 inches in length and about 0.5 inches in diameter.

14. The foam gun flashlight of claim 1, wherein the on/off switch is a push button switch located at a back end of the flashlight.
